(19) United States
(12) Patent Application Publication
(10) Pub. No.: US 2026/0087440 A1
(43) Pub. Date: Mar. 26, 2026

(54) SYSTEM FOR ASSESSING METRICS OF A BUSINESS

(71) Applicant: Predictive Risk Assessment, LLC, Ft. Lauderdale, FL (US)

(72) Inventors: Bradley A. TISDAHL, Orinda, CA (US); Elizabeth TISDAHL, Orinda, CA (US)

(21) Appl. No.: 19/338,754

(22) Filed: Sep. 24, 2025

Related U.S. Application Data
(60) Provisional application No. 63/699,327, filed on Sep. 26, 2024.

(51) Int. Cl. G06Q 10/067

(52) U.S. Cl. CPC G06Q 10/0674

(57) ABSTRACT

A system is provided. A system, including at least one computing device that is configured to determine a first set of input data associated with a business, where the first set of input data being associated with one of a plurality of predefined business sectors; select a model for analyzing data based at least on the first set of input data, where the model includes a plurality of model weights and variables associated with the one of the plurality of predefined business sectors; request, for a user via a user device, at least a third set of input data for use by the selected model, where the third set of input data being associated with the business and different from the first set of input data; analyze using the selected model.

### CROSS-REFERENCE TO RELATED APPLICATIONS

This application claims priority to U.S. Provisional Application No.: 63/699,327, filed September 26, 2024, entitled “SYSTEM FOR ASSESSING METRICS OF A BUSINESS,” the entirety of which is incorporated herein by reference.

### TECHNICAL FIELD

This disclosure relates to a method and system for assessing one or more metrics of a business.

### BACKGROUND

Assessment of a business may be performed for identifying and evaluating potential pitfalls in one or more levels of operation of a business. In one example, such an assessment may be used by the business itself to determine whether certain measures need to be taken to address one or more issues. In another example, the assessment may be used by a lending business or other business to determine the risk in investing and/or doing business with a particular business.

### SUMMARY

Some embodiments advantageously provide a method and system for assessing the metrics of a business. In particular, the assessment system allows for financial assessment of a business based on, for example, user inputs and/or system-determined inputs.

One or more embodiments provide a system for quickly assessing the financial health of a company in order to help enable some to make more informed decisions about the business.

One or more embodiments allow users to input one or more data fields to create one or more reports using a cloud-based financial model that automatically determines one or more metrics of the company based on the user input and/or additional inputs determined by the model. In one or more embodiments, the system retrieves at least some inputs from various electronic sources in order to determine one or more metrics of the company.

Further, one or more metrics may be provided according to a predefined scale, thereby allowing decision makers to quickly assess the metrics. For example, businesses may be scored on a scale of 1 – 3, with 1 being the most unstable (i.e., higher risk business) and 3 being the most stable (i.e., lower risk business).

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 is a block diagram of an example system according to some embodiments of the present disclosure;

FIG. 2 is a block diagram of an example computing environment of FIG. 1 according to some embodiments of the present disclosure;

FIG. 3 is a flowchart of an example process performed by the computing environment according to one or more or more embodiments of the present disclosure;

FIG. 4 is a flowchart of another example process performed by the computing environment according to one or more or more embodiments of the present disclosure;

FIG. 5 is a block diagram of example functions performed by the computing environment according to some embodiments of the present disclosure;

FIG. 6 is a diagram of example model calculations performed by the computing environment according to some embodiments of the present disclosure;

FIG. 7 is a block diagram of example functions performed by the computing environment according to some embodiments of the present disclosure;

FIG. 8 is a block diagram of an example of inputs and outputs of a model according to some embodiments of the present disclosure;

FIG. 9 is a diagram of an example assessment output according to some embodiments of the present disclosure; and

FIG. 10 is a diagram of another example assessment output according to some embodiments of the present disclosure.

### DETAILED DESCRIPTION

Before describing in detail exemplary embodiments, it is noted that the embodiments reside primarily in combinations of apparatus components and processing steps related to a system for assessing metrics of a business. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible for achieving the electrical and data communication.

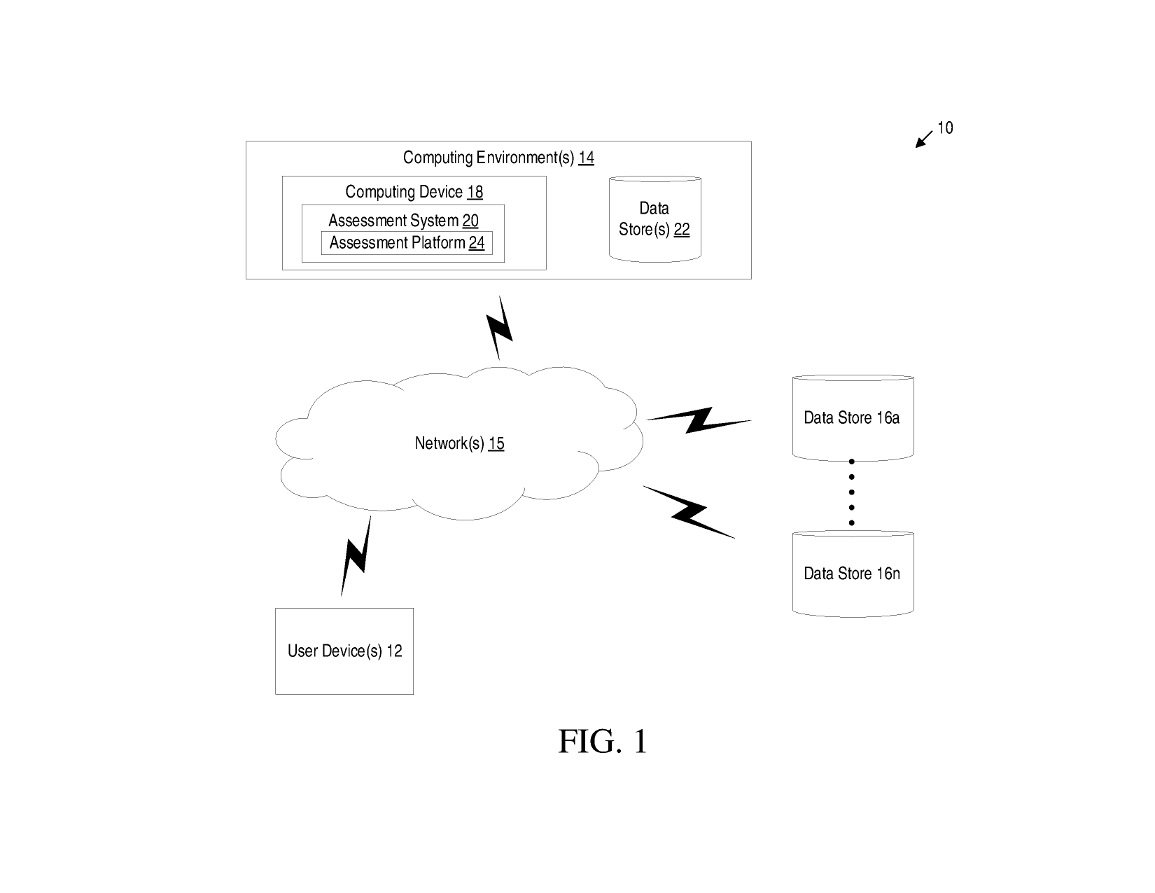

With reference to FIG. 1, shown is a block diagram of an example system 10 according to some embodiments of the present disclosure. System 10 may include one or more user devices 12 and one or more computing environments 14 that may be in communication with each other via one or more networks 15 (collectively referred to as network 15). Further, system 10 may include one or more data stores 16a-16n (collectively referred to as data store 16) that are in communication with one or more elements of system 10, such as for example, the computing environment 14.

In one or more embodiments, user device 12 may refer to one or more of a computer, laptop, mobile phone, tablet, handheld electronic device, etc. User device 12 is configured to interface and/or communicate with computing environment 14 via network 15, as described herein. User device 12 may include one or more user interfaces (e.g., buttons, touch screen, input devices, etc.) to facilitate a user interacting with user device 12.

Further, computing environment 14 may include one or more computing devices 18. In embodiments using multiple computing devices 18, the computing devices 18 may be located in a single installation or may be distributed among many different geographic locations (e.g., cloud computing environment).

Further, computing environment 14 may include assessment system 20 and data store(s) 22 for storing one or more models and/or input data, among other data that may be used by computing environment 14 to perform one or more functions described herein. Assessment system 20 is configured to provide business assessment services based on input data such as, for example, one or more user inputs and/or one or more inputs determined by assessment system 20, as described herein. In one or more embodiments, assessment platform 24 is part of and/or a sub-component of assessment system 20. Assessment platform 24 may be configured to process the various input data received using one or more models (e.g., financial models) and provide at least one output that indicates at least one metric associated with a business that was analyzed by assessment platform 24, as described herein. In one or more embodiments, assessment platform 24 is configured to modify a financial model based on, for example, at least one of the inputs. Further, assessment platform 24 may be configured to perform other functionality related to determining input data such as by querying and/or searching one or more data stores 16.

Further, data store 22 of computing environment 14 may be configured to store various information and/or data associated with performing the assessment of a business as described herein. For example, data store 22 may store at least one assessment criterion (e.g., rules, thresholds, weights, etc.), model(s), input data, previous outputs/results generated by assessment system 20, among other data that may be used by assessment platform 24 for performing the assessment described herein.

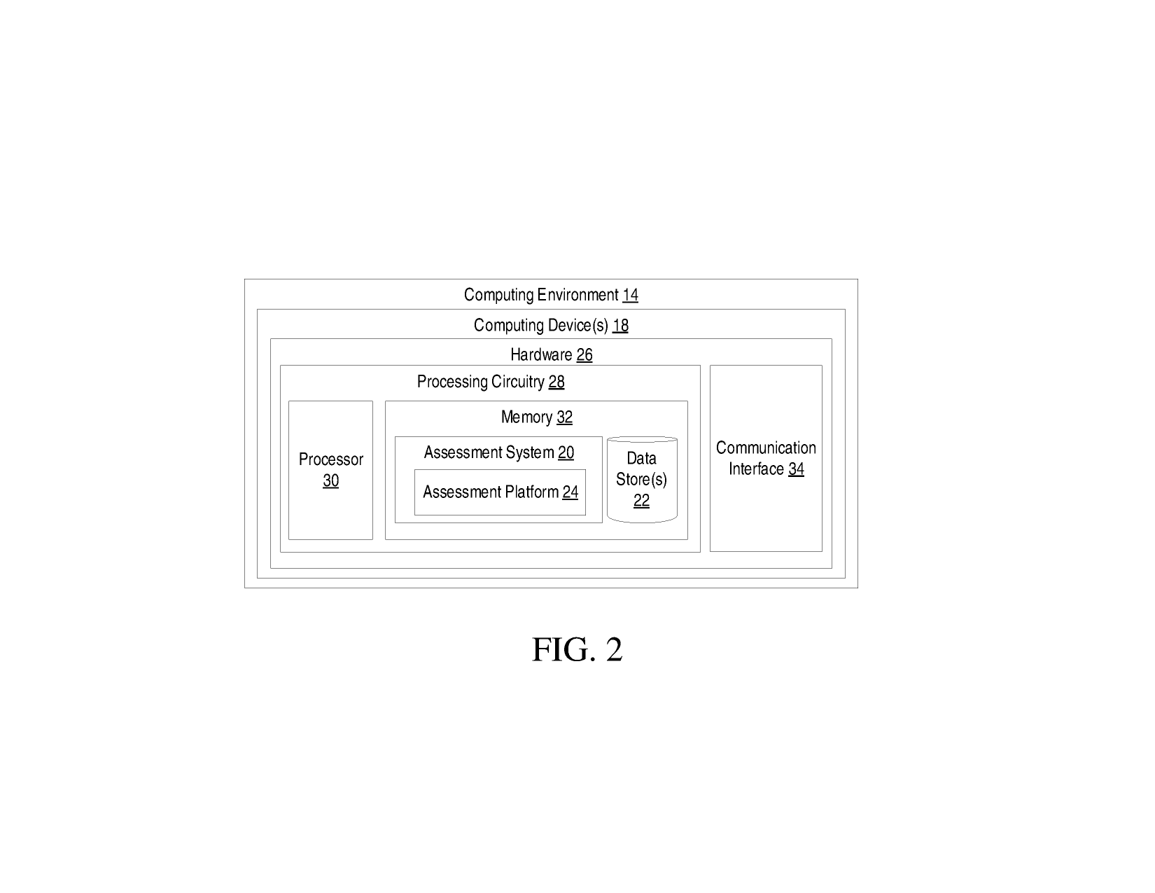

FIG. 2 is a block diagram illustrating the example computing environment 14 according to various embodiments. As shown, the computing environment 14 may include one or more computing devices 18. As shown, each computing device 18 comprises hardware 26. The hardware 26 may include processing circuitry 28. The processing circuitry 28 may include one or more processors 30 and one or more memories 32. Each processor 30 may include and/or be associated with one or more central processing units, data buses, buffers, and interfaces to facilitate operation. In addition to or instead of a processor 30 and memory 32, the processing circuitry 28 may comprise other types of integrated circuitry that perform various functionality. Integrated circuitry may include one or more processors 30, processor cores, FPGAs, ASICs, GPUs, SoCs, or other components configured to execute instructions. The processor 30 may be configured to access (e.g., write to and/or read from) the memory 32, which may comprise any kind of volatile and/or nonvolatile memory, e.g., cache, buffer memory, RAM, ROM, optical memory, and/or EPROM. Further, memory 32 may be embodied in the form of one or more storage devices. The processing circuitry 28 may be configured to perform various functionality described herein. For example, computer instructions may be stored in memory 32 and/or another computer-readable medium that, when executed by processor 30, causes the processor 30 to perform various functionality.

Hardware 26 may include communication interface 34 facilitating communication between one or more elements in system 10. For example, communication interface 34 may be configured for establishing and maintaining at least a wireless or wired connection with one or more elements of system 10 such as network 15, data store 16, user device 12, etc.

The processing circuitry 28 may be configured to control any of the methods and/or processes described herein and/or to cause such methods, and/or processes to be performed, e.g., in computing environment 14. Processor 30 corresponds to one or more processors 30 for performing computing device 18 functions described herein.

The memory 32 is configured to store data, such as files, data, information, etc. that are described herein. Also stored in the memory 32 and executable by the processor 30 are the assessment system 20 and assessment platform 24. Although FIG. 2 shows the assessment system 20 and assessment platform 24 being in a single computing device 18, the assessment system 20 and assessment platform 24 may execute in multiple computing devices 18 of the computing environment 14. To perform the functionality of the assessment system 20 and assessment platform 24, the memory 32 may include instructions that, when executed by the processor 30 and/or processing circuitry 28, causes the computing device 18 to perform the functionality performed by the assessment system 20 and assessment platform 24 described herein.

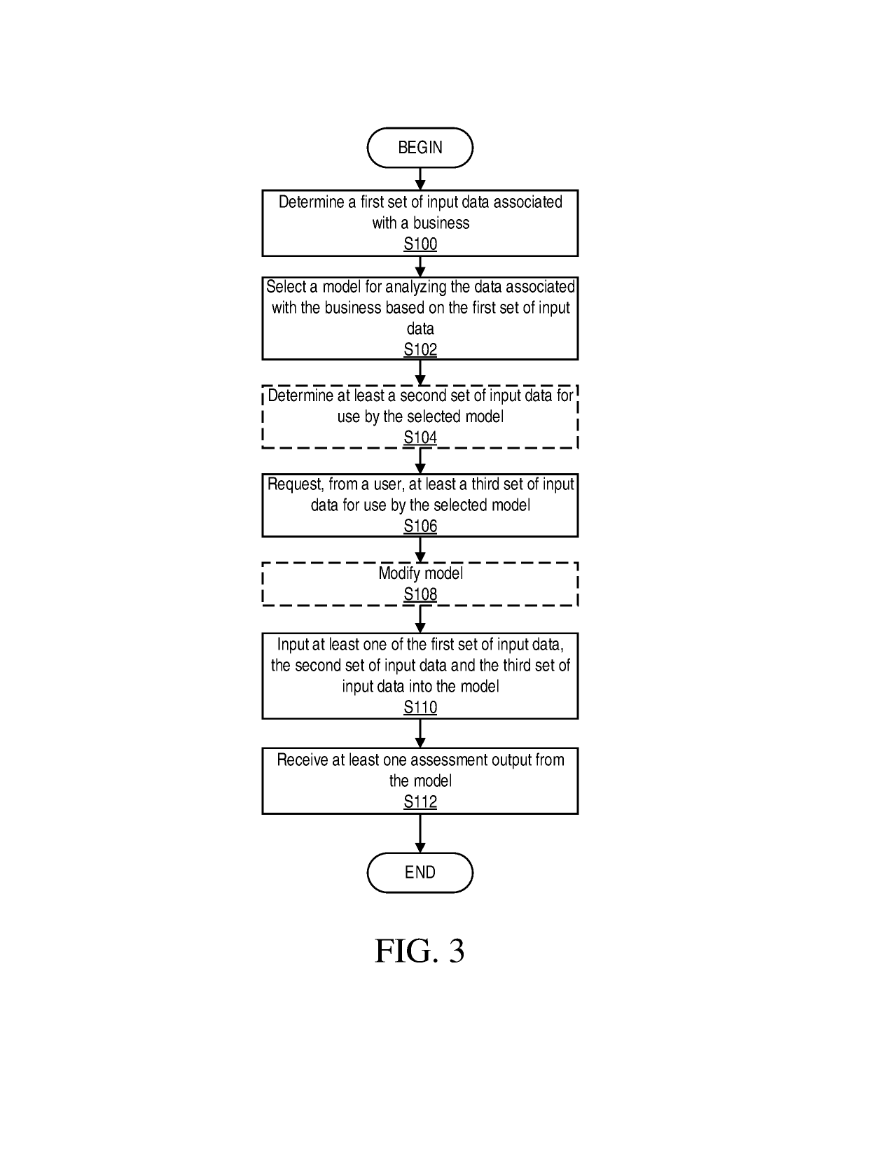

FIG. 3 is a flowchart of an example process according to some embodiments of the present disclosure. In particular, one or more functions may be performed by one or more of computing device 18, processing circuitry 28, processor 30, assessment system 20, assessment platform 24, communication interface 34, etc.

Computing environment 14 is configured to determine a first set of input data associated with a business (Block S100). For example, computing environment 14 is configured to receive the first set of input data from a user via user device 12. The first set of input data may comprise one or more of company inputs, industry type, rent inputs, etc. For example, company inputs may include one or more of a legal entity name and the state of registration of the legal entity. Industry type may correspond to one of a plurality of predefined industry types (e.g., restaurant, business services, etc.). Rent inputs may include one or more of a building name, building address associated with the business, square footage, gross rent, tenant improvement allowance, free rent, escalation, leasing commissions, lease terms, etc.

In one or more embodiments, computing environment 14 is configured to communicate with one or more data stores 16 to retrieve data associated with the business. For example, data store 16 may include the state registrations data store, ultimate beneficial ownership (UBO) data store, geolocation data store, etc.

Computing environment 14 is configured to select a model for analyzing data associated with the business based on the first set of input data (Block S102). For example, computing environment 14 is configured to select a model from a plurality of predefined models. In one or more embodiments, each model is associated with a respective industry type such that computing environment 14 may perform the selection step based at least on the industry type indicated in the first set of input data. In one or more embodiments, computing environment 14 may perform the selection step based on one or more data elements in the first set of input data.

Computing environment 14 is configured to optionally determine at least a second set of input data for use by the selected model (Block S104). For example, in one or more embodiments, computing environment 14 may determine input data for use in analyzing a business by querying and receiving data from one or more data stores 16, where data store 16 may correspond to one or more of a government data store 16, bank data store 16, public records data store 16, etc.

Computing environment 14 is configured to request, from a user, at least a third set of input data for use by the selected model (Block S106). For example, in one or more embodiments, computing environment 14 is configured to determine input data required by the selected model and query the user via user device 12 for the required input data. For example, the third set of input data may correspond to input data missing from the first set of input data, but that is required for analysis by the selected model and/or whose absence from the analysis would cause an accuracy threshold for the selected model to fall below a threshold.

In one or more embodiments, computing environment 14 may autonomously retrieve at least some of the data described above by, for example, connecting to one or more upstream data sources (e.g., security of state registrations, UBO data source, geolocation data aggregators, etc.).

Computing environment 14 is configured to optionally determine whether to modify the selected model (Block S108). For example, in one or more embodiments, computing environment 14 is configured to modify at least one criterion, variable and/or weight used by the model. The determination of whether to modify at least one criterion and by which quantity to modify the model may be based on the at least one of the first set of input data, the second set of input data, and the third set of input data. In one or more embodiments, computing environment 14 may be configured to modify the model based on historical data of the industry corresponding to the industry type and/or future projections of the industry. In one or more embodiments, the determination to modify the model is based at least on the determination of one or more of: a shift in the business cycle, change in federal reserve policy, size of the company, expected size of the company within a predefined time period (e.g., layoffs expected in four months, seasonal hiring surge expected in two months, etc.), etc. That is, the weights and/or thresholds (e.g., tolerances) that are defined by the model may be dynamically adjusted by the computing environment 14.

In some embodiments, the user may initially select a model to use for the assessment and an initial set of weights may be assigned to variables. However, computing environment 14 may adjust (e.g., sometime after the initial model selection) the thresholds for scoring of individual variables and/or the corresponding weights that are assigned to the variables based on data received from one or more databases and/or the user. For example, one or more weights may be adjusted based on a shift in a business cycle, a dramatic change in Federal Reserve policy (e.g., a change in interest rates above a predefined threshold), etc., where these changes can be autonomously determined by computing environment 14. In another example, computer environment 14 may dynamically change one or more inputs based on a type of company being assessed, e.g., type of company associated with at least some of the input being input. For example, the type of company may be associated with one of the following sectors: restaurant, retail, business and consumer services, professional services, law firm, manufacturing, medical office, software company, personal guarantee, etc. One or more of these sectors may be associated with and/or correspond to a specific set of thresholds, weights, etc. that may be used by the model as the initial thresholds and/or weights for analysis. In one example, one or more weights may be adjusted based on a determined size of the business. In one or more embodiments, as the user inputs are received and processed by the model, the model may dynamically adjust one or more weights and/or thresholds for analysis.

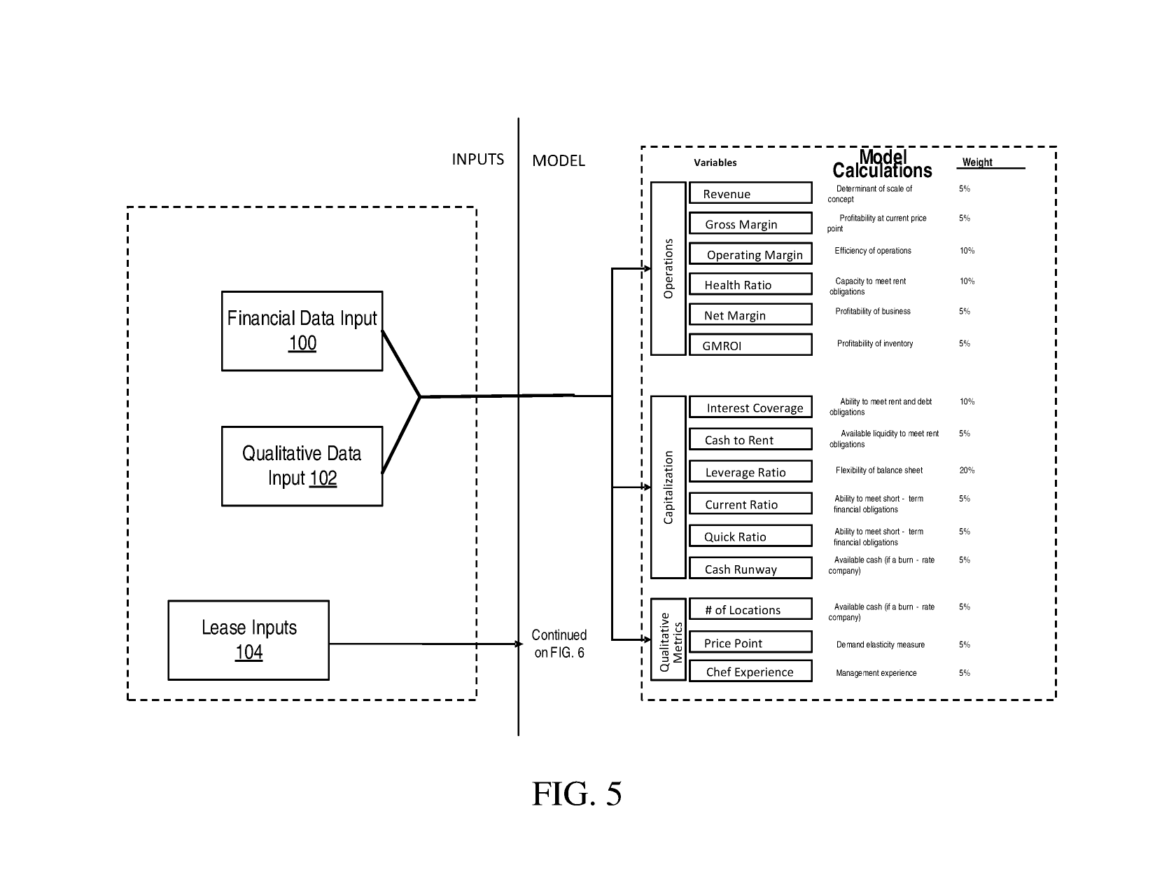

Computing environment 14 is configured to input at least some of the first set of input data, the second set of input data and the third set of input data into the model (Block S110). An example of at least some of the inputs being input into the model for calculation is shown in FIGS. 5-7.

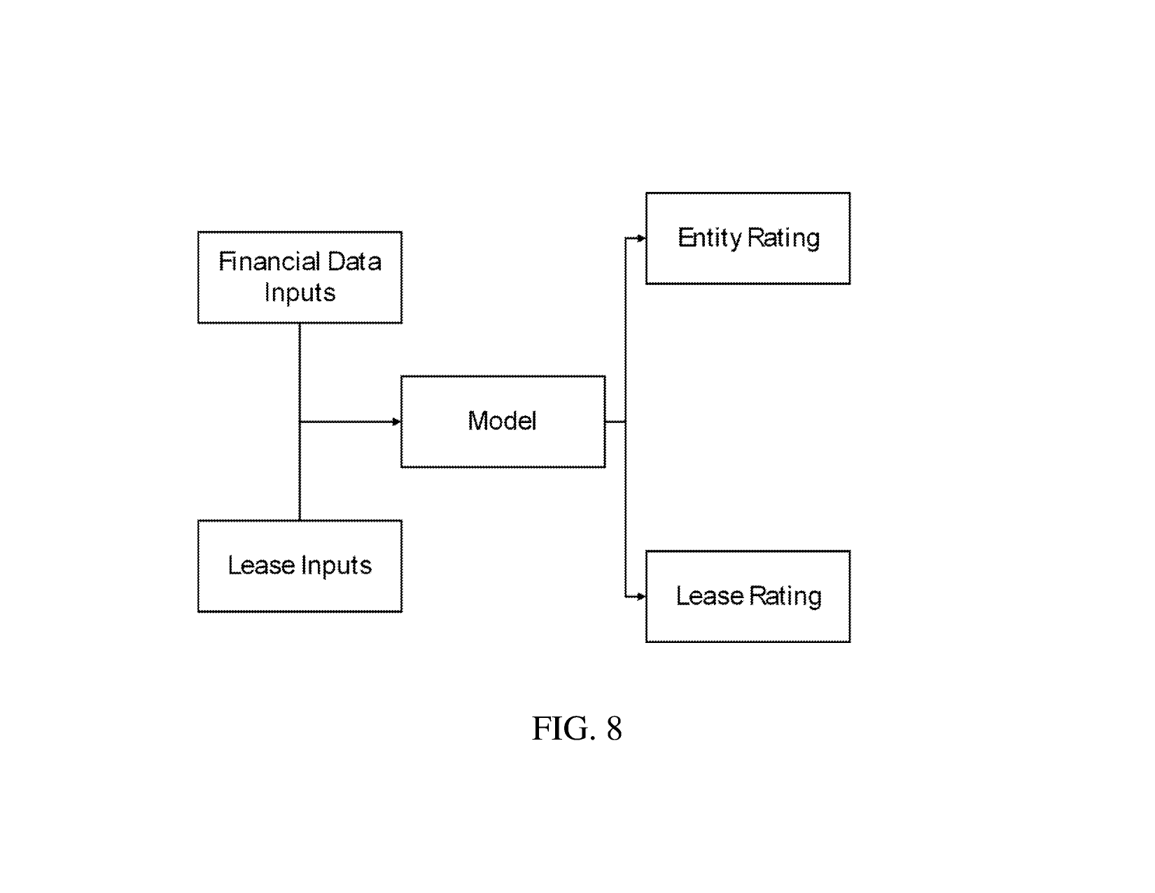

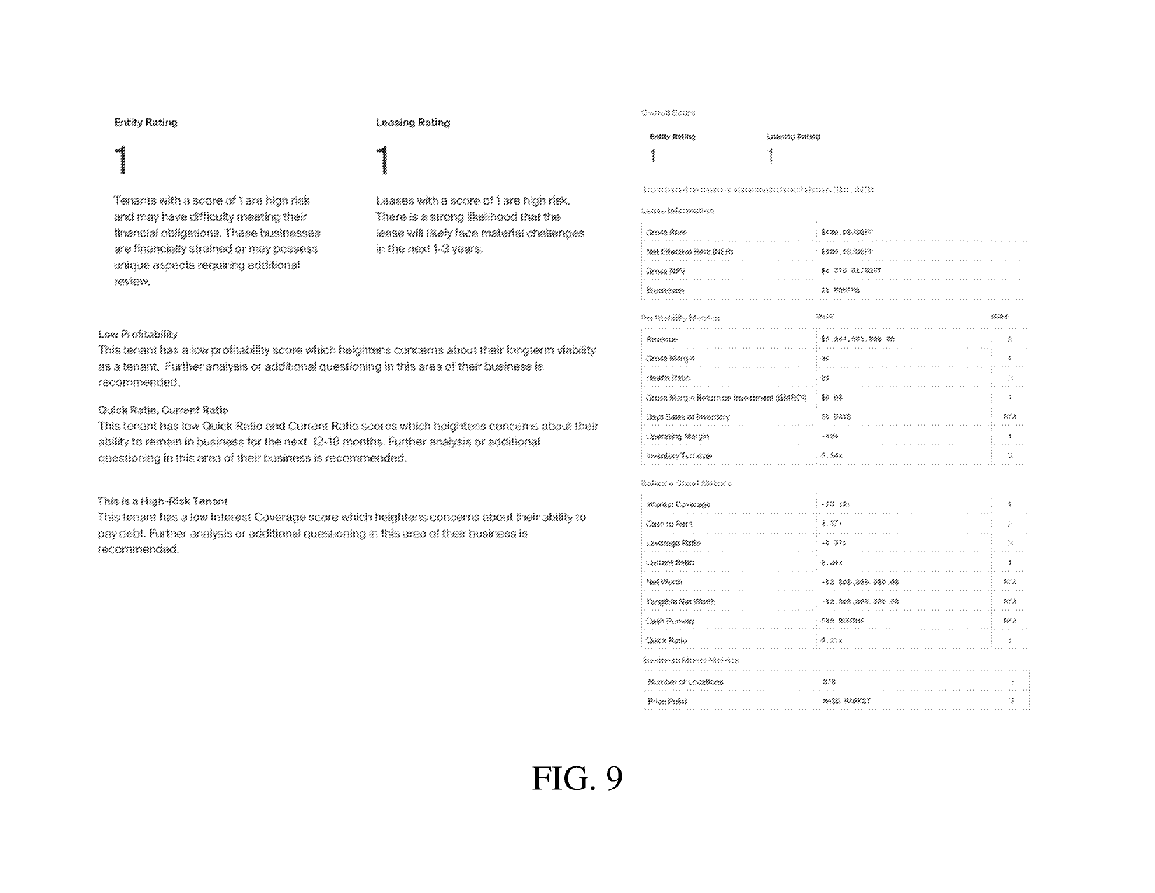

Computing environment 14 is configured to receive at least one assessment output from the model (Block S112). For example, in one or more embodiments, computing environment 14 outputs one or more metrics associated with the analysis of the business using the model. In some embodiments, the metrics may comprise an entity rating and/or lease rating, although other metrics may be output based on various input data. For example, in one or more embodiments, computing environment 14 transmits the assessment output to user device 12 for user device 12 to display the results. Examples of the assessment outputs are shown in FIGS. 8-9.

For example, computing environment 14 input data into the model and then the model scores the variables based on one or more thresholds/weights and/or one or more adjusted threshold/weights. For example, in a restaurant model, if the “Revenue” input is $3 million ($3M), the model scores the “Revenue” variable as a 1.00, which currently has a 5% weight attached to the overall entity score. If the user inputs “Revenue” of $20M, the model will automatically score the “Revenue” variable as a 2.00 with the weight of 5% to the overall entity score. If the user inputs “Revenue” of 100M, the model will score the “Revenue” variable as 3.00 with the weight of 5%. The model may perform a similar process with the other variables and then perform the weighted average sum of each variable to derive the entity score. In one or more embodiments, the model the model may determine if one or more thresholds (e.g., entity score threshold, weighted average sum threshold, quick ratio threshold, etc.) are met. The model may tag the one or more variables meeting the one or more thresholds as a “1.00.”

In one or more embodiments, computing environment 14 is configured to highlight variables that the model rates as a “1.00” in the final output. Text is presented to the user in the assessment output indicates what the 1.00 rating means and why it demonstrates weakness for the entity being rated. In one or more embodiments, computing environment 14 indicates, in the assessment output, how the entity rating would change and what the rated entity (e.g., business) would need to do to improve this metric.

In one or more embodiments, the computing instructions are further configured to cause the at least one computing device to: determine at least a second set of input data for use by the selected model at least in part by: determining at least some input data that is required by the selected model for performing at least one model calculation; and querying at least one data store for at least some input data.

In one or more embodiments, computing environment 14 is configured to track tenant credit quality on an ongoing basis and provide alerts when there is a change in at least a portion of the assessment output, e.g., a change in at least one rating, etc. In one example, the tracking and updating of the assessment output may occur continuously or periodically over a predefined period.

In one or more embodiments, computing environment 14 is configured to synchronize with at least one other system through at least one application program interface (API) to pull and/or publish data.

In one or more embodiments, computing environment 14 is configured with additional metrics and/or thresholds for additional industries, thereby providing industry-specific metrics and/or thresholds for evaluating other industries. In one or more embodiments, the computing environment 14 may combine metrics and/or thresholds from various industries to generate a hybrid model used for analyzing a non-standard industry.

In one or more embodiments, computing environment 14 is configured to anonymize data and track financial metrics by industry to create a commercial real estate credit risk index by industry or sector.

In one or more embodiments, computing environment 14 is configured to automatically update credit metric scoring thresholds based on statistically significant changes in the credit metrics over a predefined period of time.

In one or more embodiments, computing environment 14 is configured to “read” uploaded financial statements and extract relevant information that may be required for input into the system.

According to one or more embodiments, the computing instructions are further configured to cause the at least one computing device to: determine whether to modify the selected model based at least on the first set of input data, the second set of input data and the third set of input data, and in response to determining to modify the selected model, alter or adjust at least one of: at least one weight of the selected model and at least one variable of the selected model.

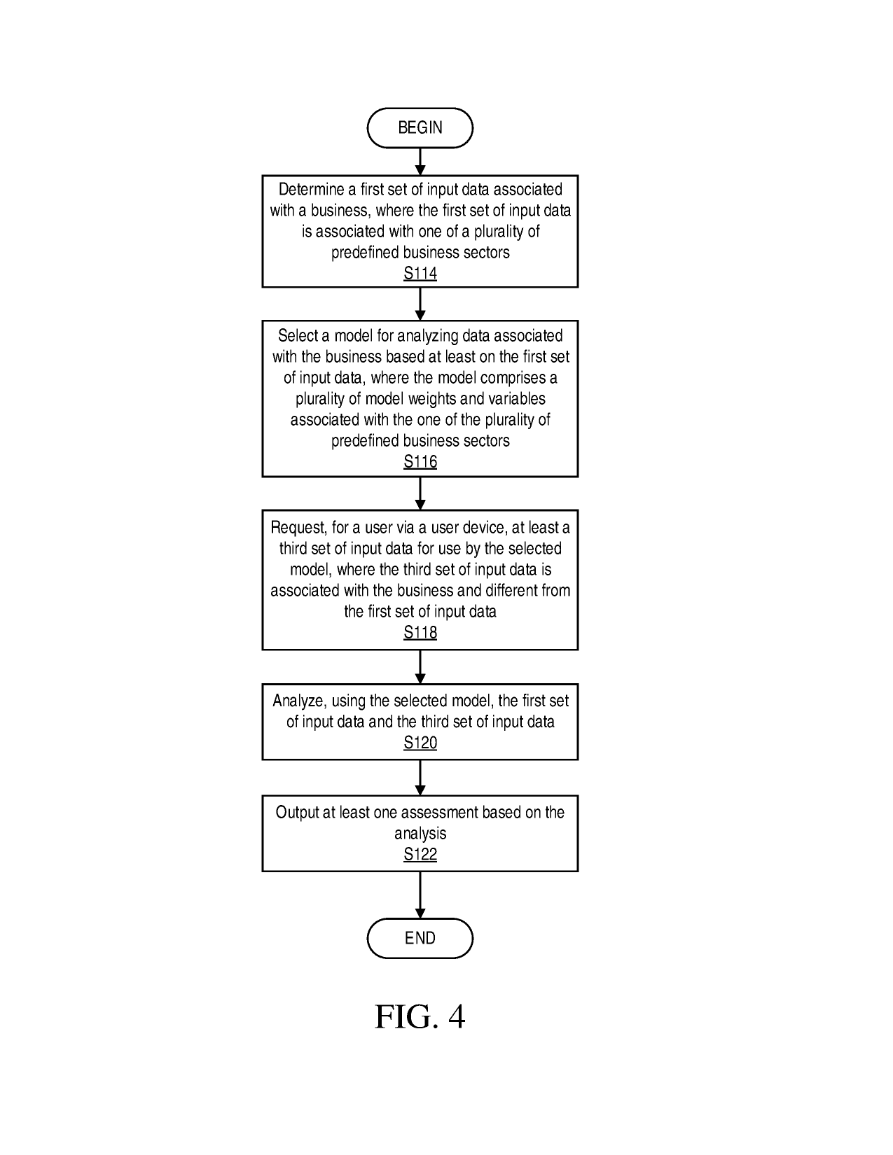

FIG. 4 is a flowchart of another example process according to some embodiments of the present disclosure. In particular, one or more functions may be performed by one or more of computing device 18, processing circuitry 28, processor 30, assessment system 20, assessment platform 24, communication interface 34, etc. According to one or more embodiments, a system comprises at least one computing device 18 that is configured to determine (Block S114) a first set of input data associated with a business, the first set of input data being associated with one of a plurality of predefined business sectors, as described herein. The at least one computing device 18 is further configured to select (Block S116) a model for analyzing data associated with the business based at least on the first set of input data, where the model comprises a plurality of model weights and variables associated with the one of the plurality of predefined business sectors, as described herein.

The at least one computing device 18 is further configured to request (Block S118), for a user via a user device, at least a third set of input data for use by the selected model, where the third set of input data is associated with the business and different from the first set of input data, as described herein. The at least one computing device 18 is further configured to analyze (Block S120), using the selected model, the first set of input data and the third set of input data, as described herein. The at least one computing device 18 is further configured to output (Block S122) at least one assessment based on the analysis, as described herein.

According to one or more embodiments, the at least one computing device is further configured to: determine at least a second set of input data for use by the selected model at least in part by: determining at least some input data that is required by the selected model for performing at least one model calculation; querying at least one data store for at least some input data, and where the data store is one of a government data store, bank data store and public records data store.

According to one or more embodiments, the at least one computing device is further configured to: determine to modify the selected model; in response to determining to modify the selected model, alter or adjust at least one of: at least one weight of the selected model; and at least one variable of the selected model, and in response to the altering or adjusting, re-analyze, using the selected model, the first set of input data and the third set of input data; and output at least one updated assessment based on the re-analysis of the first set of input data and the third set of input data.

According to one or more embodiments, the determination to modify the selected model is based on one or more of: the first set of input data; the second set of input data; the third set of input data; and the at least one assessment output of the model.

According to one or more embodiments, the determination to modify the selected model is based on the first set of input data and the at least one assessment output of the model.

According to one or more embodiments, the determination to modify is based on one or more of: a shift in a business cycle as determined by the at least one computing device; a change in federal reserve policy as determined by the at least one computing device; and an expected size of the business within a predefined time period as determined by the at least one computing device.

According to one or more embodiments, the first set of input data comprises: one or more business inputs, the one or more business inputs comprising one or more of: a legal entity name of the business and a registration of the legal entity; an indication of the one of a plurality of predefined business sectors associated with the business; and one or more rent inputs, the one or more rent inputs comprising one or more of: a building name associated with the business, a building address of a building associated with the business, square footage of the building, gross rent associated with the building, leasing commissions associated with the building and lease terms associated with the building.

According to one or more embodiments, the third set of input data is associated with input data that is required by the selected model for analysis but that is missing from the first set of input data.

FIG. 5 is a block diagram of example functions performed by the computing environment 14 according to some embodiments of the present disclosure. In one or more embodiments, the financial data input 100 may correspond to data associated with one or more of the first set of input data, the second set of input data and the third set of input data. In one or more embodiments, the qualitative data input 102 may correspond to data associated with one or more of the first set of input data, the second set of input data, and the third set of input data. In one or more embodiments, lease inputs 104 may correspond to one or more of the first set of input data, the second set of input data, and the third set of input data.

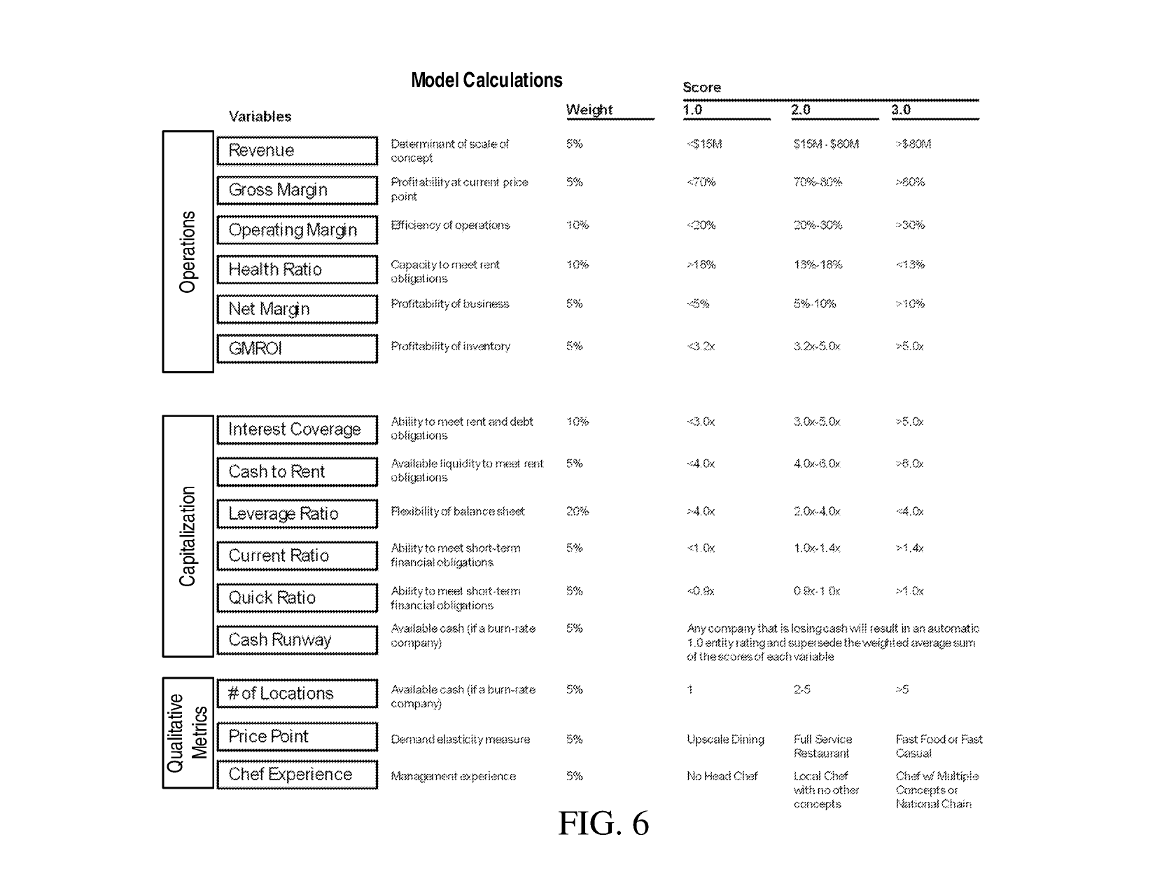

For example, financial data associated with financial data input 100 and qualitative data associated with qualitative data input 102 is input into a model (e.g., selected model) that comprises one or more variables (e.g., revenue, gross margin, etc.) and one or more weights (e.g., 5%, 10%, etc.) for performing one or more model calculations for outputting, for example, at least one assessment. In some examples, the assessment includes one or more scores as shown in FIG. 6.

FIG. 6 is a diagram of an example model calculations performed by computing environment (e.g., performed by assessment system 20 and/or assessment platform 24) according to some embodiments of the present disclosure. The model may comprise a plurality of weights that are used to weigh at least some of the input data. Further, the model may comprise one or more predefined thresholds for scoring at least some of the weighted input data. For example, in the restaurant model of FIG. 6, if the input data “Revenue” is $3M, computing environment 14 will score the “Revenue” variable as a 1.00, which has a 5% weight attached to the overall entity score. If the input data “Revenue” is $20M, computing environment 14 automatically score the “Revenue” variable as a 2.00 with the weight of 5% to the overall entity score. And if the input data “Revenue” is $100M, computing environment 14 will score the “Revenue” variable as a 3.00 along with the 5% weight. Computing environment 14 performs calculations and/or determinations with all the variables and then performs the weighted average sum of each variable to derive the entity score, unless one of the “circuit breakers” is triggered, where a circuit breaker may correspond to one or more thresholds that, when triggered, results in a predefined value (e.g., entity rating) irrespective of other input data. Some examples of a circuit breaker comprise one or more of the following: if the company’s “Current Ratio” is below 1.00x, if the company’s the “Quick Ratio” is below 0.90x, or if the company is operating at a loss, etc. In some embodiments, if any one of the circuit breakers is hit, then the entity rating will be a 1.00. In some embodiments, one or more circuit breakers may be turned on or off based on, for example, some input data. In some embodiments, one or more circuit breakers may be adjusted and/or modified such that to change the level at which the one or more circuit breakers are triggered.

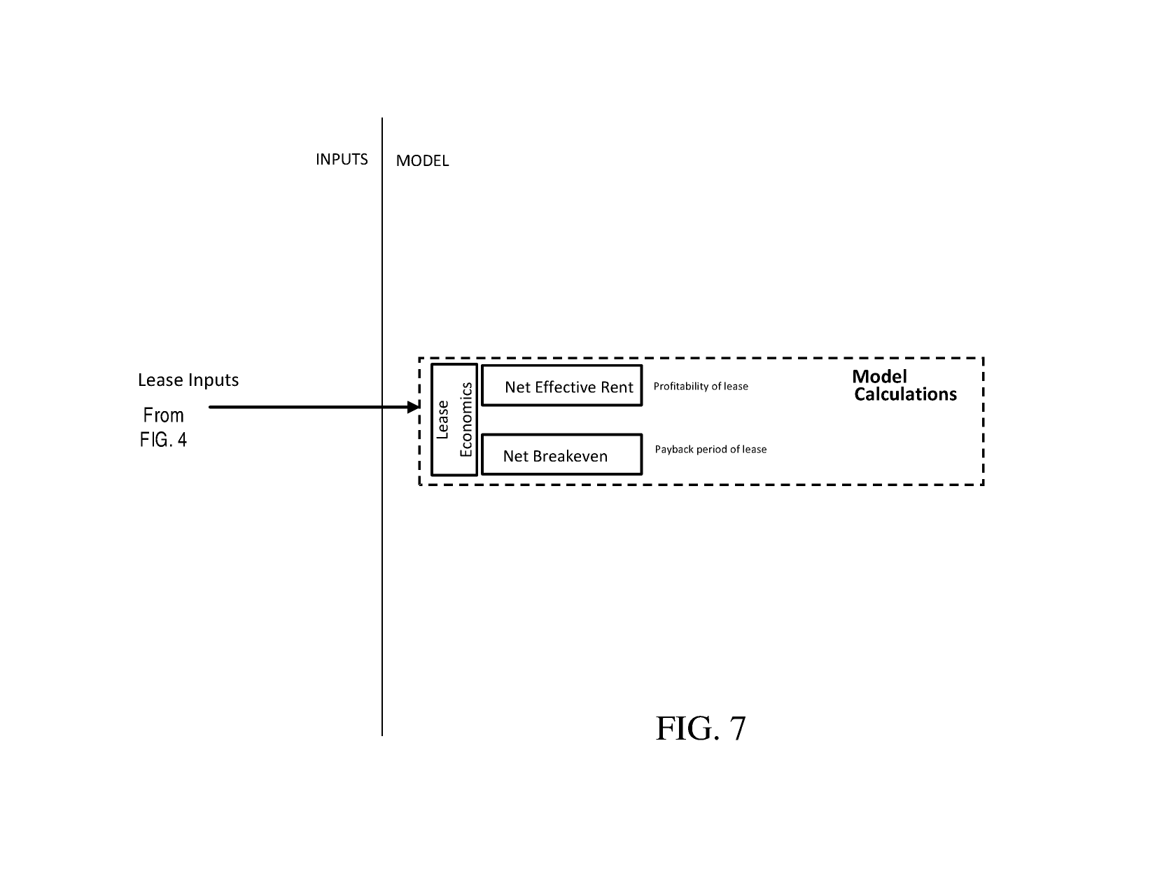

FIG. 7 is a block diagram of example functions performed by the computing environment 14 according to some embodiments of the present disclosure. In one or more embodiments, the model may be configured to process the lease inputs by performing model calculations on the lease inputs. For example, computing environment 14 may calculate a net effective rent and a net breakeven.

FIG. 8 is a block diagram of an example of inputs and outputs of a model according to some embodiments of the present disclosure.

FIG. 9 is a diagram of an example assessment output according to some embodiments of the present disclosure.

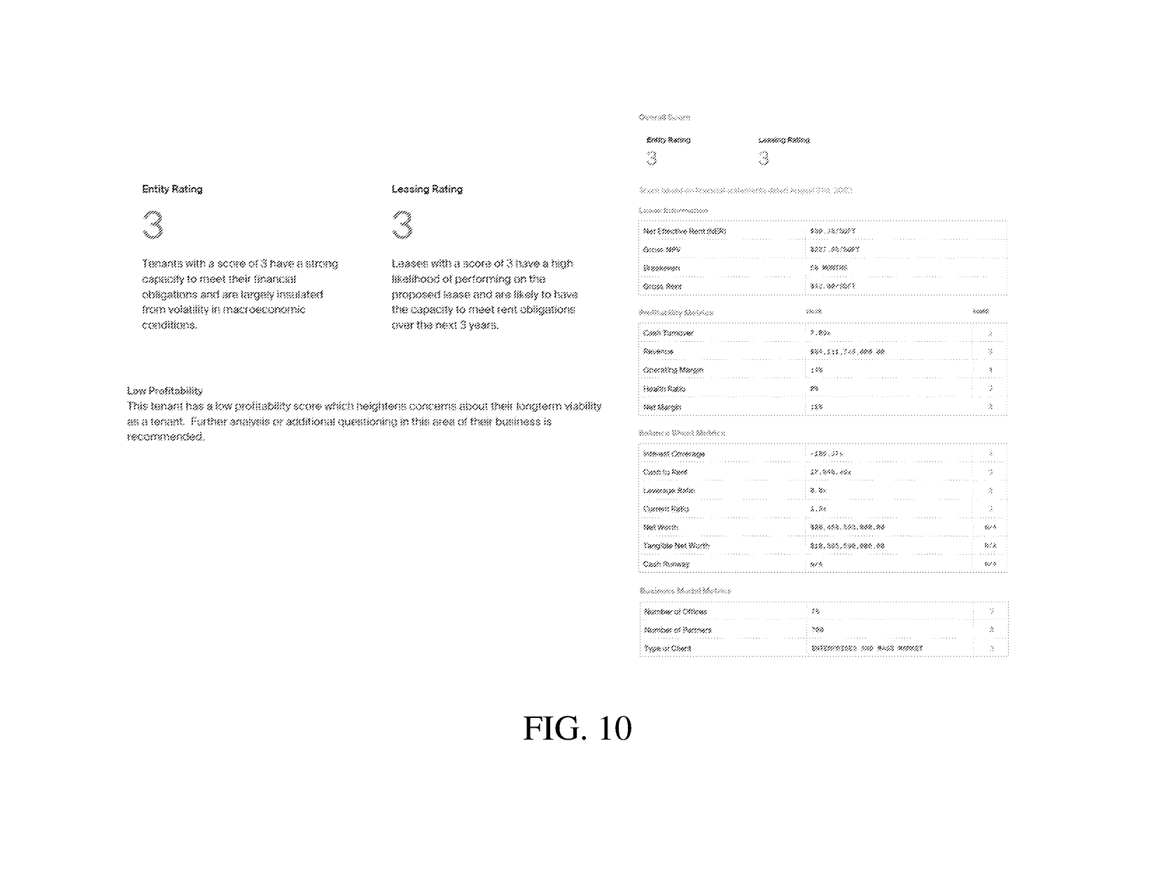

FIG. 10 is a diagram of another example assessment output according to some embodiments of the present disclosure.

### SOME EXAMPLES

According to one or more embodiments, a system is provided. The system comprises at least one computing device comprising: at least one processor and at least one memory storing computing instructions that, when executed by the at least one processor, cause the at least one computing device to: determine a first set of input data associated with a business; select a model for analyzing data associated with the business based at least on the first set of input data; request, for a user via a user device, at least a third set of input data for use by the selected model; input at least the first set of input data and the third set of input data into the selected model; and receive at least one assessment output from the model.

According to one or more embodiments, the computing instructions are further configured to cause the at least one computing device to: determine at least a second set of input data for use by the selected model at least in part by: determining at least some input data that is required by the selected model for performing at least one model calculation; and querying at least one data store for at least some input data.

According to one or more embodiments, the computing instructions are further configured to cause the at least one computing device to: determine whether to modify the selected model based at least on the first set of input data, the second set of input data and the third set of input data; and in response to determining to modify the selected model, alter or adjust at least one of: at least one weight of the selected model; and at least one variable of the selected model.

According to another aspect of the present disclosure, a method implemented by a system is provided. A first set of input data associated with a business are determined. A model for analyzing data associated with the business is selected based at least on the first set of input data. At least a third set of input data for use by the selected model is requested for a user via a user device. At least the first set of input data and the third set of input data are input into the selected model. At least one assessment output from the model is received.

According to one or more embodiments, at least a second set of input data for use by the selected model is determined at least in part by: determining at least some input data that is required by the selected model for performing at least one model calculation and querying at least one data store for at least some input data.

According to one or more embodiments, a determination is made whether to modify the selected model based at least on the first set of input data, the second set of input data and the third set of input data. In response to determining to modify the selected model, altering or adjusting at least one of: at least one weight of the selected model; and at least one variable of the selected model.

The concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspect. Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. Each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions and/or acts specified in the flowchart and/or block diagram block or blocks.

The functions and acts noted in the blocks may occur out of the order noted in the operational illustrations. For example, two blocks shown in succession may, in fact, be executed substantially concurrently, or the blocks may sometimes be executed in the reverse order, depending upon the functionality and/or acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Python, Java® or C++. However, the computer program code for carrying out operations of the disclosure may also be written in conventional procedural programming languages, such as the "C" programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

In addition, unless mention was made above to the contrary, the accompanying drawings are not to scale. A variety of modifications and variations are possible in light of the above teachings and the following claims.

1. A system, comprising:
at least one computing device comprising:
at least one processor; and
at least one memory storing computing instructions that, when executed by the at least one processor, cause the at least one computing device to:
determine a first set of input data associated with a business, the first set of input data being associated with one of a plurality of predefined business sectors;
select a model for analyzing data associated with the business based at least on the first set of input data, the model comprising a plurality of model weights and variables associated with the one of the plurality of predefined business sectors;
request, for a user via a user device, at least a third set of input data for use by the selected model, the third set of input data being associated with the business and different from the first set of input data;
analyze, using the selected model, the first set of input data and the third set of input data; and
output at least one assessment based on the analysis.

2. The system of claim 1, wherein the computing instructions are further configured to cause the at least one computing device to:
determine at least a second set of input data for use by the selected model at least in part by:
determining at least some input data that is required by the selected model for performing at least one model calculation;
querying at least one data store for at least some input data; and
the data store being one of a government data store, bank data store and public records data store.

3. The system of claim 2, wherein the computing instructions are further configured to cause the at least one computing device to:
determine to modify the selected model;
in response to determining to modify the selected model, alter or adjust at least one of:
at least one weight of the selected model; and
at least one variable of the selected model; and
in response to the altering or adjusting, re-analyze, using the selected model, the first set of input data and the third set of input data; and
output at least one updated assessment based on the re-analysis of the first set of input data and the third set of input data.

4. The system of claim 3, wherein the determination to modify the selected model is based on one or more of:
the first set of input data;
the second set of input data;
the third set of input data; and
the at least one assessment output of the model.

5. The system of claim 3, wherein the determination to modify the selected model is based on the first set of input data and the at least one assessment output of the model.

6. The system of claim 4, wherein the determination to modify is based on one or more of:
a shift in a business cycle as determined by the at least one computing device;
a change in federal reserve policy as determined by the at least one computing device; and
an expected size of the business within a predefined time period as determined by the at least one computing device.

7. The system of claim 1, wherein the first set of input data comprises:
one or more business inputs, the one or more business inputs comprising one or more of: a legal entity name of the business and a registration of the legal entity;
an indication of the one of a plurality of predefined business sectors associated with the business; and
one or more rent inputs, the one or more rent inputs comprising one or more of: a building name associated with the business, a building address of a building associated with the business, square footage of the building, gross rent associated with the building, leasing commissions associated with the building and lease terms associated with the building.

8. The system of claim 1, wherein the third set of input data is associated with input data that is required by the selected model for analysis but that is missing from the first set of input data.

9. A method implemented by at least one computing device, the method comprising:
determining a first set of input data associated with a business, the first set of input data being associated with one of a plurality of predefined business sectors;
selecting a model for analyzing data associated with the business based at least on the first set of input data, the model comprising a plurality of model weights and variables associated with the one of the plurality of predefined business sectors;
requesting, for a user via a user device, at least a third set of input data for use by the selected model, the third set of input data being associated with the business and different from the first set of input data;
analyzing, using the selected model, the first set of input data and the third set of input data; and
outputting at least one assessment based on the analysis.

10. The method of claim 9, further comprising:
determining at least a second set of input data for use by the selected model at least in part by:
determining at least some input data that is required by the selected model for performing at least one model calculation;
querying at least one data store for at least some input data; and
the data store being one of a government data store, bank data store and public records data store.

11. The method of claim 10, further comprising:
determining to modify the selected model;
in response to determining to modify the selected model, altering or adjusting at least one of:
at least one weight of the selected model; and
at least one variable of the selected model; and
in response to the altering or adjusting, re-analyzing, using the selected model, the first set of input data and the third set of input data; and
outputting at least one updated assessment based on the re-analysis of the first set of input data and the third set of input data.

12. The method of claim 11, wherein the determination to modify the selected model is based on one or more of:
the first set of input data;
the second set of input data;
the third set of input data; and
the at least one assessment output of the model.

13. The method of claim 11, wherein the determination to modify the selected model is based on the first set of input data and the at least one assessment output of the model.

14. The method of claim 12, wherein the determination to modify is based on one or more of:
a shift in a business cycle as determined by the at least one computing device;
a change in federal reserve policy as determined by the at least one computing device; and
an expected size of the business within a predefined time period as determined by the at least one computing device.

15. The method of claim 9, wherein the first set of input data comprises:
one or more business inputs, the one or more business inputs comprising one or more of: a legal entity name of the business and a registration of the legal entity;
an indication of the one of a plurality of predefined business sectors associated with the business; and
one or more rent inputs, the one or more rent inputs comprising one or more of: a building name associated with the business, a building address of a building associated with the business, square footage of the building, gross rent associated with the building, leasing commissions associated with the building and lease terms associated with the building.

16. The method of claim 9, wherein the third set of input data is associated with input data that is required by the selected model for analysis but that is missing from the first set of input data.
